(19) United States
(12) Patent Application Publication
(10) Pub. No.: US 2009/0146874 A1
(43) Pub. Date: Jun. 11, 2009

(54) GPS module and computer system using the same

(75) Inventors: Chu-Chia Tsai, Taipei Hsien (TW); Wen-Chin Wu, Taipei Hsien (TW); Chia-Hsien Li, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: Wistron Corporation, Taipei Hsien (TW)

(21) Appl. No.: 12/216,016

(22) Filed: Jun. 27, 2008

(30) Foreign Application Priority Data
Dec. 5, 2007 (TW) 096146406

(51) Int. Cl. G01S 1/00

(52) U.S. Cl. 342/357.06

(57) ABSTRACT

A global positioning system module and a computer system using the same are disclosed. The global positioning system module comprises a circuit board and a connection interface; the circuit board comprises a signal receiving module for receiving a wireless (satellite) signal and a signal transmission module for communicating with the computer wirelessly; the connection interface is electrically connected to the circuit board, and it may enable the global positioning system module insertable into the expansion slot so as to electrically connect the global positioning system module and the computer.

### BACKGROUND OF THE INVENTION

1. Field of the Invention

The present invention relates to a global positioning system (GPS) module and, more particularly, to a GPS module capable of communicating with a computer wirelessly and insertable into an expansion card of the computer.

2. Description of the Related Art

In order to increase the safety and convenience, drivers generally use a GPS to plan the route in advance to get to where they want to go. In addition to a standalone GPS that is installable in a vehicle independently, a built-in or externally mountable GPS module has recently been developed. This type of module allows users to execute the functions of a GPS via the installation of the GPS module in a portable electronic device (e.g. a notebook computer or an ultra mobile personal computer). However, both types of GPS module have some drawbacks in use. For example, when a GPS module is built into a notebook computer, the antenna of the GPS module has to be disposed around the liquid crystal display panel. Since most notebook computers already have antennas or functional modules for different purposes (e.g. WIFi, Wimax, 802.11n, ultra wideband, or video capturing), normally no space with good signal reception is available for the antenna of the GPS module. Moreover, due to the consideration of signal reception in a vehicle, the notebook computer has to be placed as close to the front of the vehicle as possible, which consequently blocks the drivers' view. Besides, stable installation of the notebook computer also creates a big problem.

The externally installed GPS module is a receiver of a wireless (satellite) positioning signal; it may transmit the signal to the notebook computer in a wired or wireless manner and provides the notebook computer with the functions of wireless (satellite) positioning. A GPS Mouse and a GPS wireless receiver are components of the GPS module of this kind. Usually, the utility of the GPS Mouse is limited by the length of a transmission line because the connection between the notebook computer and the GPS Mouse is achieved by the transmission line; the GPS wireless receiver, on the other hand, fails to fit the needs of different occasions because its power capacity information is relatively low or it has to be charged by a charger in the vehicle. Furthermore, since both the GPS Mouse and the GPS wireless receiver are external devices, they do not provide good portability. In addition, there is another type of GPS receiver, which is shaped like a memory card and works only when inserted into the memory slot of a notebook computer. The GPS receiver possesses properties and functions similar to those of the built-in GPS module and has similar problems.

Therefore, it is desirable to provide an improved method to mitigate and/or obviate the aforementioned problems.

### SUMMARY OF THE INVENTION

It is therefore an object of the present invention to provide a global positioning system module for communicating with a computer, the global positioning system module being insertable into an expansion slot of the computer when said module is not in use.

The global positioning system module of this invention comprises a circuit board and a connection interface; the circuit board comprises a signal receiving module for receiving a wireless (satellite) signal and a signal transmission module for communicating with the computer wirelessly; the connection interface is electrically connected to the circuit board, and it may enable the global positioning system module insertable into the expansion slot so as to electrically connect the global positioning system module and the computer.

The global positioning system module further comprises a battery module electrically connected to the circuit board for providing power such that the computer may exteriorly recharge the battery module when the global positioning system module is inserted into the expansion slot through the connection interface.

The global positioning system module further comprises a memory disposed on the circuit board for storing information relating to the wireless (satellite) signal; thus, the global positioning system module of this invention may store the information when it is not in communication with the computer and read the information from the computer afterwards.

The present invention also provides a computer system comprising a computer and the aforementioned global positioning system module. The computer comprises an expansion slot; the global positioning system module is both capable of communicating with the computer wirelessly and insertable into the expansion slot. Accordingly, the computer system of this invention has the function of a global positioning system and is highly portable.

Other objects, advantages, and novel features of the invention will become more apparent from the following detailed description when taken in conjunction with the accompanying drawings.

### BRIEF DESCRIPTION OF THE DRAWINGS

These and other objects and advantages of the present invention will become apparent from the following description of the accompanying drawings, which disclose several embodiments of the present invention. It is to be understood that the drawings are to be used for purposes of illustrations only, and not as a definition of the invention.

In the drawings, wherein similar reference numerals denote similar elements throughout the several views:

FIG. 1 is a block diagram of the global positioning system module of this invention.

FIG. 2 is an explosive view of the global positioning system module of this invention.

FIGS. 3(a) and 3(b) are illustrative diagrams showing different use statuses of the global positioning system module of this invention.

FIGS. 4(a) and 4(b) are illustrative diagrams showing the global positioning system module of this invention used in different situations.

FIG. 5 is an illustrative diagram showing the layout of the circuit board of one embodiment of the global positioning system module of this invention.

FIG. 6 is an illustrative diagram of the computer system of this invention.

### DETAILED DESCRIPTION OF THE PREFERRED EMBODIMENT

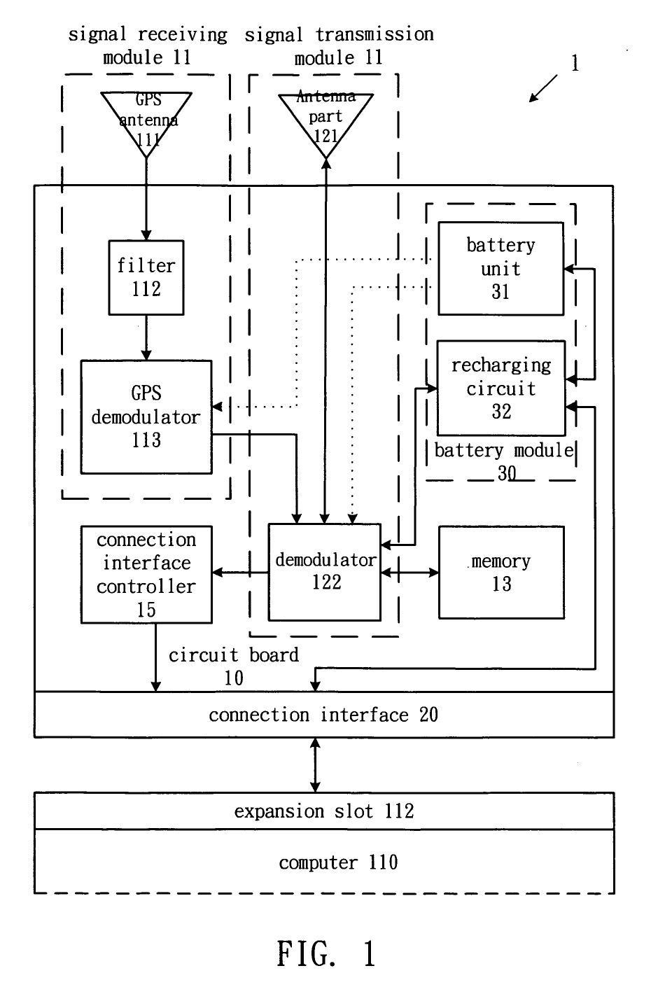

Refer to FIG. 1 for a block diagram of the global positioning system module of this invention. As shown in FIG. 1, the global positioning system module 1 comprises a circuit board 10 and a connection interface 20; the circuit board 10 comprises a signal receiving module 11 for receiving a wireless (satellite) signal and a signal transmission module 12 for communicating with a computer 110 wirelessly. The signal receiving module 11 comprises a GPS antenna 111, a filter 112, and a GPS demodulator 113; the wireless (satellite) signal is received by the GPS antenna 111, and its noise is removed by the filter 112; the signal is also enhanced by the filter 112 and converted by the GPS demodulator 113. The GPS demodulator 113 comprises a memory (not shown) for processing the signal in a real time manner. The signal transmission module 12 comprises an antenna part 121 and a demodulator 122; the signal transmitted by the GPS demodulator 113 is processed by the demodulator 122 and transmitted wirelessly to the computer 110 by the antenna part 121. It is noted that the signal transmission module 12 is capable of communicating with the computer 110 without limitation via Bluetooth transmission, radio transmission, radio frequency (RF) transmission, ultra wideband (UWB) transmission, 802.11n transmission, Zig Bee transmission, Wi-Fi transmission, Wimax transmission, or other kinds of wireless communication protocols. The connection interface 20 is electrically connected to the circuit board 10 such that the global positioning system module 1 may be inserted into the expansion slot 112 of the computer 110 and electrically connected to the computer 110. With the design mentioned above, users may place the global positioning system module 1 at any position within the wireless transmission range of the computer 110; in addition, the global positioning system module 1 may be inserted in the expansion slot 112 of the computer 110 after use, largely increasing the portability of the global positioning system module 1 of this invention.

The global positioning system module 1 may further comprise a battery module 30 electrically connected to the circuit board 10 for providing power. The battery module 30 comprises a battery unit 31 for providing power to the components on the circuit board 10 and a recharging circuit 32 disposed on the circuit board 10 for receiving and converting the power supplied externally so as to recharge the battery unit 31. When the global positioning system module 1 is inserted into the expansion slot 112 through the connection interface 20, the computer 110 may provide the power needed by the global positioning system module 1, and the battery module 13 may be recharged accordingly. Thus, the global positioning system module 1 may always be exteriorly recharged by the computer 110 when not in use so that users can keep the global positioning system module 1 at full capacity.

The circuit board 10 of the global positioning system module 1 may further comprise a memory 13 for storing information from the wireless (satellite) signal. When the global positioning system module 1 is offline (i.e. not in communication with the computer 110), the global positioning system module 1 may still receive the information from the wireless (satellite) positioning signal and temporarily store the information in the memory 13. After being connected electrically to the computer 110, the global positioning system module 1 may transmit the information to the computer 110 via a connection interface controller 15 and the connection interface 20; then the computer 110 is capable of analyzing and utilizing the data. For example, the information may constitute a track record, and the global positioning system module 1 may work as a track recorder to provide users with information on their driving route.

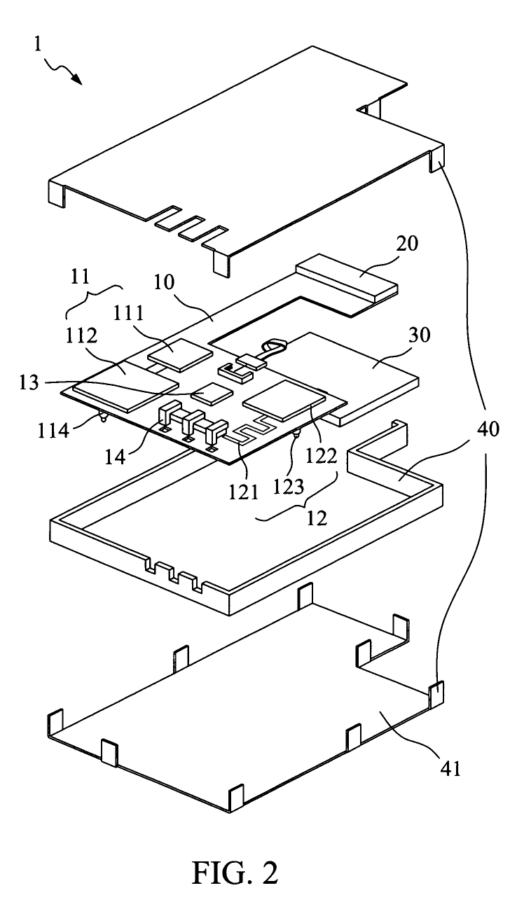

Refer to FIG. 2 for an explosive view of the global positioning system module of this invention. The global positioning system module 1 may further comprise a housing 40 for accommodating the circuit board 10, the connection interface 20, and the battery module 30. The housing 40 may comprise a metal lower cover 41. Each of the signal receiving module 11 and the signal transmission module 12 comprises grounding parts 114 and 123 respectively connected to the metal lower cover 41. With the grounding effect generated by the grounding parts 114 and 123 in contact with the metal lower cover 41, the metal lower cover 41 may work as the large grounding part of the GPS antenna 111 of the signal receiving module 11 and the antenna part 121 of the signal transmission module 12, largely enhancing the capability of the signal receiving module 11 and the signal transmission module 12. Moreover, the circuit board 10 may further comprise an indication module 14 for displaying the transmission status of the global positioning system module 1 or the capacity information of the battery module 30. In this embodiment, the indication module 14 is a light-emitting diode (LED) indicator, but it may also be without limitation a voicing element or other indication elements.

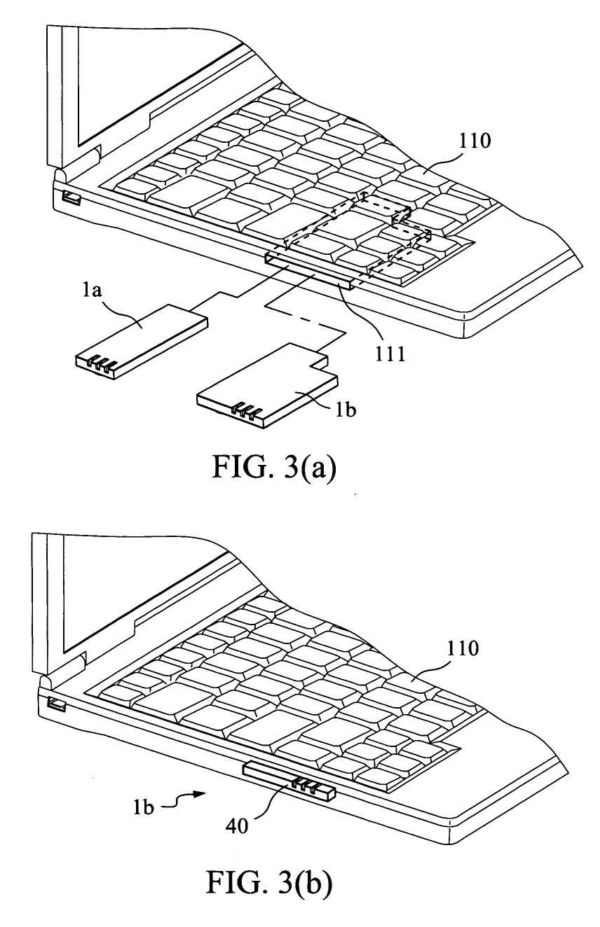

Refer to FIGS. 3(a) and 3(b) for illustrative diagrams showing different use statuses of the global positioning system module of this invention. As shown in FIG. 3(a), the global positioning system module 1a or 1b may be an expansion card corresponding to the expansion slot 111 of the computer 110. In this embodiment, the global positioning system module 1a or 1b may correspond to a PCI-Express 34/54 slot, a PCMCIA slot, or any other expansion slot 111 and may not be limited thereto. As shown in FIG. 3(b), which uses the PCI-Express 54 slot as an example, the global positioning system module 1b is insertable into the expansion slot 111 after use; accordingly, users may carry the global positioning system module 1b easily and exteriorly recharge it with the computer 110. In addition, a part of the housing 40 may be exposed outside of the expansion slot 111 after the insertion of the global positioning system module 1b so that users may dismount the global positioning system module 1b easily.

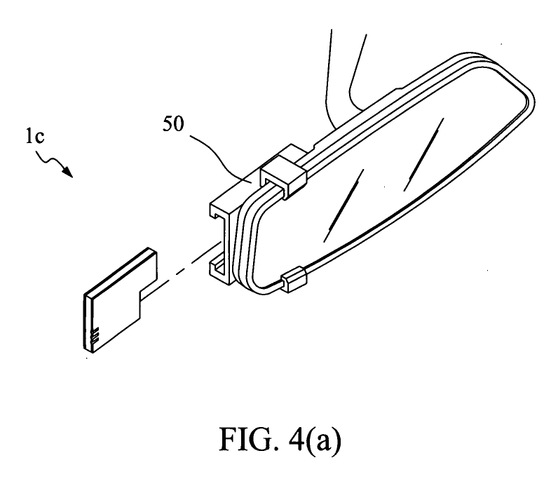

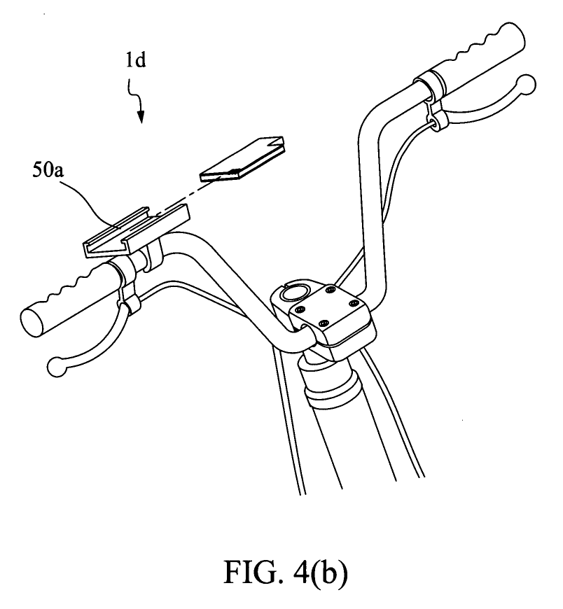

Refer to FIGS. 4(a) and 4(b) for illustrative diagrams showing the global positioning system module of this invention used in different situations. The global positioning system module 1c or 1d may further comprise a fastening part 50 or 50a for securing the global positioning system module 1c or 1d on a part of a vehicle and providing stable disposition of the global positioning system module 1c or 1d. As shown in FIG. 4(a), the global positioning system module 1c is applicable to a four-wheeled vehicle; in this embodiment, the global positioning system module 1c is secured on the rearview mirror in the car via the fastening part 50 such that the global positioning system module 1c may not cause any negative effect to the driver's view when in use; in addition, the computer 110 may be disposed at any position capable of forming a wireless communication with the global positioning system module 1c. As shown in FIG. 4(b), the global positioning system module 1d is applicable to a two-wheeled vehicle; in this embodiment, the global positioning system module 1d is secured to the handle bars of a bicycle via the fastening part 50a. When no communication with the computer can be formed, the offline mode mentioned above may be used to record the path information. It should be noted that the global positioning system module 1c or 1d may be without limitation secured on any position of a vehicle by the fastening part 50 or 50a, such as on the seat or on the frame.

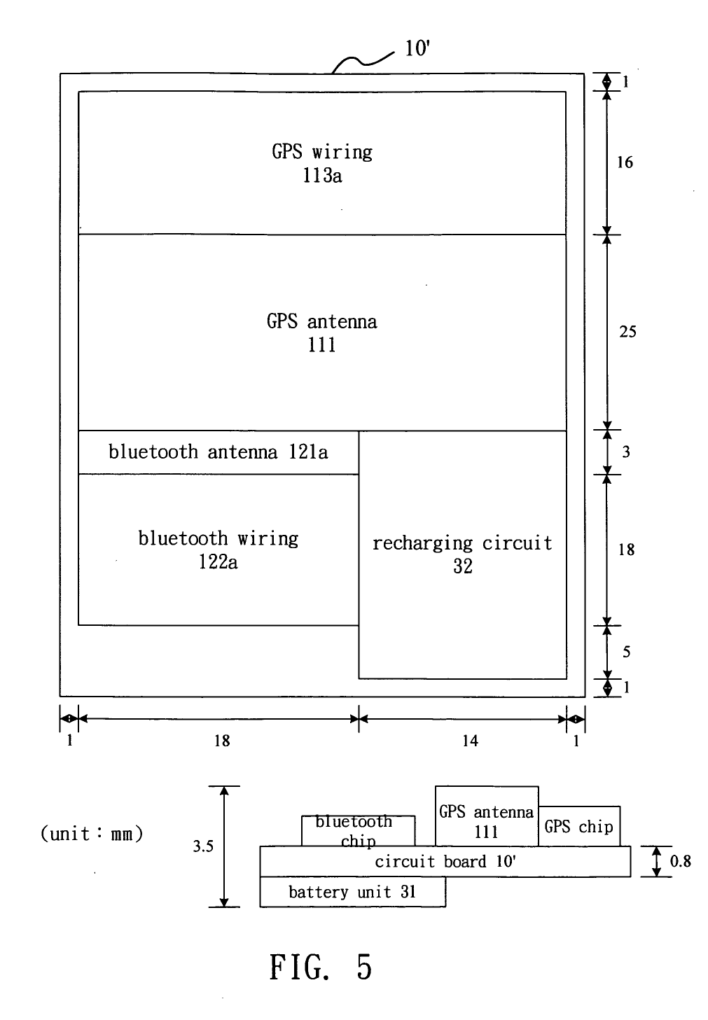

Refer to FIG. 5 for an illustrative diagram showing the layout of the circuit board of one embodiment of the global positioning system module of this invention. The size of a standard PCI-Express 34 card is about 75 mm*34 mm*5 mm; as shown in FIG. 5, the size of the global positioning system module is in compliance with the size of a standard PCI-Express 34 card. The circuit board 10′ is also designed in such a way that it may be accommodated in a housing of a standard PCI-Express 34 card. The GPS wiring 113a comprises a GPS chip for processing the GPS signal and other related wirings; the Bluetooth wiring 122a comprises a Bluetooth chip for processing the transmission signal and other related wirings. On the circuit board 10′, a 1 mm margin is left for certain use; the rear end of the circuit board 10 may be connected to a connection interface (not shown). The battery unit 31 is disposed under the circuit board 10′. In this embodiment, the GPS antenna 111 is the Yageo 1.575 GHz ceramic antenna, which has a size of 25 mm*25 mm*25 mm; the GPS chip disposed on the GPS wiring 113a is the 7 mm*10 mm*1.4 mm CiRFstarIII chip of GSC3e/LP and GSC3f/LP manufactured by SirG; the Bluetooth chip disposed on the Bluetooth wiring 122a is the 8 mm*8 mm*1.2 mm BlueCore4-External chip manufactured by Cambridge Silicon Radio. With the aforementioned design, the size of the circuit board 10′ with other components may be in compliance with the size of a standard PCI-Express 34 card and provide a thinned effect. However, it should be noted that the components mentioned above may also be replaced by other components as long as the size may be accommodated in a standard PCI-Express 34 card.

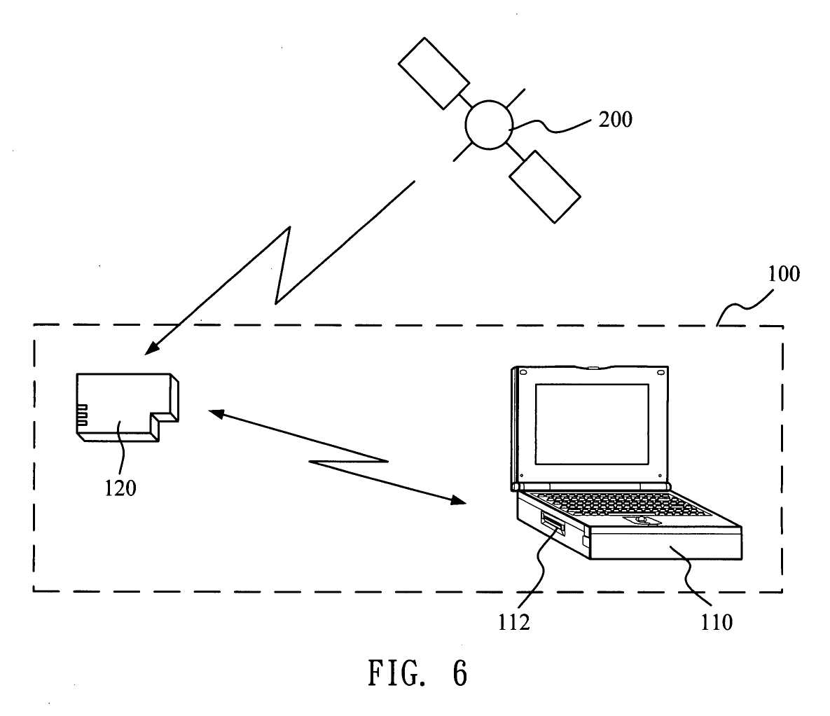

Refer to FIG. 6 for an illustrative diagram of the computer system of this invention. As shown in FIG. 6, the computer system 100 of this invention comprises a computer 110 and a global positioning system module 120 as mentioned above. The computer 110 comprises an expansion slot 112; the global positioning system module 120 is capable of communicating with the computer 110 and insertable into the expansion slot 112. The global positioning system module 120 may receive the signal emitted from the satellite 200 and transmit the signal wirelessly to the computer 110 when a connection between the global positioning system module 120 and the computer 1 10 is established; when the global positioning system module 120 is offline, it may store the received signal and transmit the stored signal to the computer 110 afterwards. Moreover, the global positioning system module 120 is insertable into the expansion slot 112 after use, providing users with great portability and the ability to exteriorly recharge the module. It should be noted that the computer 110 in this embodiment may also be without limitation a notebook computer or an ultra mobile personal computer.

Although the present invention has been explained in relation to its preferred embodiments, it is to be understood that many other possible modifications and variations can be made without departing from the spirit and scope of the invention as hereinafter claimed.

What is claimed is:

1. A global positioning system module insertable into an expansion slot of a computer, the global positioning system module comprising:
a circuit board comprising a signal receiving module for receiving a wireless signal and a signal transmission module for communicating with the computer wirelessly; and
a connection interface electrically connected to the circuit board, the connection interface enabling the global positioning system module insertable into the expansion slot so as to electrically connect the global positioning system module and the computer.

2. The global positioning system module as claimed in claim 1, wherein the expansion slot is a PCMCIA slot or a PCI-Express 34/54 slot.

3. The global positioning system module as claimed in claim 1, further comprising a battery module electrically connected to the circuit board for providing power such that the computer may recharge the battery module when the global positioning system module is inserted into the expansion slot through the connection interface.

4. The global positioning system module as claimed in claim 1, wherein the circuit board further comprises an indication module for displaying the transmission status of the global positioning system module or the capacity information of the battery module.

5. The global positioning system module as claimed in claim 1, wherein the circuit board further comprises a memory for storing information relating to the wireless signal.

6. The global positioning system module as claimed in claim 1, further comprising a housing for accommodating the circuit board and the connection interface, the housing comprising a metal lower cover.

7. The global positioning system module as claimed in claim 6, wherein each of the signal receiving module and the signal transmission module comprises a grounding part connected to the metal lower cover.

8. The global positioning system module as claimed in claim 1, further comprising a fastening part for securing the global positioning system module on a part of a vehicle.

9. The global positioning system module as claimed in claim 1, wherein the signal transmission module is capable of communicating with the computer via Bluetooth transmission, radio transmission, radio frequency transmission, ultra wideband transmission, 802.11n transmission, Zig Bee transmission, Wi-Fi transmission, or Wimax transmission.

10. A computer system, comprising:
a computer comprising an expansion slot; and
a global positioning system module insertable into the expansion slot, the global positioning system module comprising:
a circuit board comprising a signal receiving module for receiving a wireless signal and a signal transmission module for communicating with the computer wirelessly; and
a connection interface electrically connected to the circuit board, the connection interface enabling the global positioning system module insertable into the expansion slot so as to electrically connect the global positioning system module and the computer.

11. The computer system as claimed in claim 10, wherein the expansion slot is a PCMCIA slot or a PCI-Express 34/54 slot.

12. The computer system as claimed in claim 10, further comprising a battery module electrically connected to the circuit board for providing power such that the computer may recharge the battery module when the global positioning system module is inserted into the expansion slot through the connection interface.

13. The computer system as claimed in claim 10, wherein the circuit board further comprises an indication module for displaying the transmission status of the global positioning system module or the capacity information of the battery module.

14. The computer system as claimed in claim 10, wherein the circuit board further comprises a memory for storing information relating to the wireless signal.

15. The computer system as claimed in claim 10, further comprising a housing for accommodating the circuit board and the connection interface, the housing comprising a metal lower cover.

16. The computer system as claimed in claim 15, wherein each of the signal receiving module and the signal transmission module comprises a grounding part connected to the metal lower cover.

17. The computer system as claimed in claim 10, further comprising a fastening part for securing the global positioning system module on a part of a vehicle.

18. The computer system as claimed in claim 10, wherein the signal transmission module is capable of communicating with the computer via Bluetooth transmission, radio transmission, radio frequency transmission, ultra wideband transmission, 802.11n transmission, Zig Bee transmission, Wi-Fi transmission, or Wimax transmission.
